(19) United States
(12) Patent Application Publication
(10) Pub. No.: US 2018/0111398 A1
(43) Pub. Date: Apr. 26, 2018

(54) INKJET PRINTER

(71) Applicant: MIMAKI ENGINEERING CO., LTD., Nagano (JP)

(72) Inventor: Masaru OHNISHI, Nagano (JP)

(73) Assignee: MIMAKI ENGINEERING CO., LTD., Nagano (JP)

(21) Appl. No.: 15/788,806

(22) Filed: Oct. 20, 2017

(30) Foreign Application Priority Data
Oct. 20, 2016 (JP) 2016-205920

(51) Int. Cl. B41J 25/00; B41J 2/21

(52) U.S. Cl. CPC B41J 25/006; B41J 2/21

(57) ABSTRACT

An inkjet printer that causes inkjet heads to discharge ink regardless of whether a moving direction of a carriage with respect to a recording medium is either direction in a main scanning direction indicated with an arrow has ink discharging ranges by the inkjet heads that discharge inks of primary colors and ink discharging ranges by the other inkjet heads that discharge inks of secondary colors, the ink discharging ranges being arranged so as not to overlap in the main scanning direction, and allows only one of the inkjet heads to discharge ink and allows only one of the other inkjet heads to discharge ink with respect to a same position in the recording medium.

### CROSS REFERENCE TO RELATED APPLICATIONS

This application claims the priority benefit of Japanese Patent Application No. 2016-205920, filed on Oct. 20, 2016. The entirety of the above-mentioned patent application is hereby incorporated by reference herein and made a part of this specification.

### TECHNICAL FIELD

The present disclosure relates to an inkjet printer that executes printing by discharging ink toward a recording medium.

### DESCRIPTION OF THE BACKGROUND ART

A conventionally known inkjet printer includes a plurality of inkjet heads that discharge ink toward a recording medium; a main scanning direction moving unit that relatively moves the plurality of inkjet heads in a main scanning direction with respect to the recording medium; a sub-scanning direction moving unit that relatively moves the recording medium in a sub-scanning direction orthogonal to the main scanning direction with respect to the plurality of inkjet heads; and an ink discharging unit that causes the inkjet heads to discharge ink when the direction of relative movement of the plurality of inkjet heads with respect to the recording medium is the main scanning direction (see e.g., Japanese Unexamined Patent Publication No. 2009-233911).

As shown in FIG. 4A, the inkjet printer described in Japanese Unexamined Patent Publication No. 2009-233911 includes a carriage 911 relatively moved in the main scanning direction, indicated with an arrow 901, and the sub-scanning direction, indicated with an arrow 902, with respect to a recording medium (not shown). Furthermore, the inkjet printer described in Japanese Unexamined Patent Publication No. 2009-233911 includes a yellow inkjet head 912 with a nozzle row 912a arrayed in the sub-scanning direction, a magenta inkjet head 913 with a nozzle row 913a arrayed in the sub-scanning direction, a cyan inkjet head 914 with a nozzle row 914a arrayed in the sub-scanning direction, and a black inkjet head 915 with a nozzle row 915a arrayed in the sub-scanning direction. In other words, the inkjet printer described in Japanese Unexamined Patent Publication N. 2009-233911 adopts a four color plate method of executing printing with four colors: yellow, magenta, cyan, and black. The inkjet heads 912, 913, 914, 915 are lined in this order in a direction indicated with an arrow 901a in the main scanning direction.

The inkjet printer shown in FIG. 4A may discharge ink with a plurality of inkjet heads among the inkjet heads 912 to 914 to the same position in the recording medium. For example, the inkjet printer shown in FIG. 4A discharges ink with the inkjet head 912 for yellow serving as a primary color and the inkjet head 913 for magenta serving as a primary color to the same position in the recording medium when reproducing red serving as a secondary color with the primary colors. Furthermore, the inkjet printer shown in FIG. 4A discharges ink with the inkjet head 912 for yellow serving as a primary color and the inkjet head 914 for cyan serving as a primary color to the same position in the recording medium when reproducing green serving as a secondary color with the primary colors. Moreover, the inkjet printer shown in FIG. 4A discharges ink with the inkjet head 913 for magenta serving as a primary color and the inkjet head 914 for cyan serving as a primary color to the same position in the recording medium when reproducing blue serving as a secondary color with the primary colors. In addition, the inkjet printer shown in FIG. 4A may discharge ink with the inkjet head 912 for yellow serving as a primary color, the inkjet head 913 for magenta serving as a primary color, and the inkjet head 914 for cyan serving as a primary color to the same position in the recording medium when reproducing black serving as a tertiary color with the primary colors.

The inkjet printer shown in FIG. 4A discharges ink with the inkjet heads 912 to 914 to the same position in the recording medium during one relative movement of the carriage 911 with respect to the recording medium in the direction indicated with the arrow 901a when discharging ink with the inkjet heads 912 to 914 to the same position in the recording medium. The inkjet printer shown in FIG. 4A discharges ink with the inkjet heads 912 to 914 to the same position in the recording medium during one relative movement of the carriage 911 with respect to the recording medium in a direction indicated with an arrow 901b opposite the direction indicated with the arrow 901a when discharging ink with the inkjet heads 912 to 914 to the same position in the recording medium.

When discharging ink with the inkjet heads 912 to 914 to the same position in the recording medium during one relative movement of the carriage 911 with respect to the recording medium in the direction indicated with the arrow 901a, the inkjet printer shown in FIG. 4A attaches a cyan ink onto the recording medium with the inkjet head 914, attaches a magenta ink onto the cyan ink with the inkjet head 913, and attaches a yellow ink onto the magenta ink with the inkjet head 912. Therefore, when drawing red with the inkjet heads 912 and 913 in the relative movement of the carriage 911 with respect to the recording medium in the direction indicated with the arrow 901a, for example, the inkjet printer shown in FIG. 4A tends to obtain a yellowish color due to the influence of the yellow ink present on a layer of the magenta ink. Furthermore, when drawing green with the inkjet heads 912 and 914 in the relative movement of the carriage 911 with respect to the recording medium in the direction indicated with the arrow 901a, for example, the inkjet printer shown in FIG. 4A tends to obtain a yellowish color due to the influence of the yellow ink present on a layer of the cyan ink. Moreover, when drawing blue with the inkjet heads 913 and 914 in the relative movement of the carriage 911 with respect to the recording medium in the direction indicated with the arrow 901a, for example, the inkjet printer shown in FIG. 4A tends to obtain a reddish color due to the influence of the magenta ink present on a layer of the cyan ink. In addition, when drawing black with the inkjet heads 912 to 914 in the relative movement of the carriage 911 with respect to the recording medium in the direction indicated with the arrow 901a, for example, the inkjet printer shown in FIG. 4A tends to obtain a yellowish color due to the influence of the yellow ink present on layers of the magenta ink and the cyan ink.

On the other hand, when discharging ink with the inkjet heads 912 to 914 to the same position in the recording medium during one relative movement of the carriage 911 with respect to the recording medium in the direction indicated with the arrow 901b, the inkjet printer shown in FIG. 4A attaches the yellow ink onto the recording medium with the inkjet head 912, attaches the magenta ink onto the yellow ink with the inkjet head 913, and attaches the cyan ink onto the magenta ink with the inkjet head 914. Therefore, when drawing red with the inkjet heads 912 and 913 in the relative movement of the carriage 911 with respect to the recording medium in the direction indicated with the arrow 901b, for example, the inkjet printer shown in FIG. 4A tends to obtain a reddish color due to the influence of the magenta ink present on a layer of the yellow ink. Furthermore, when drawing green with the inkjet heads 912 and 914 in the relative movement of the carriage 911 with respect to the recording medium in the direction indicated with the arrow 901b, for example, the inkjet printer shown in FIG. 4A tends to obtain a blueish color due to the influence of the cyan ink present on a layer of the yellow ink. Moreover, when drawing blue with the inkjet heads 913 and 914 in the relative movement of the carriage 911 with respect to the recording medium in the direction indicated with the arrow 901b, for example, the inkjet printer shown in FIG. 4A tends to obtain a blueish color due to the influence of the cyan ink present on a layer of the magenta ink. In addition, when drawing black with the inkjet heads 912 to 914 in the relative movement of the carriage 911 with respect to the recording medium in the direction indicated with the arrow 901b, for example, the inkjet printer shown in FIG. 4A tends to obtain a blueish color due to the influence of the cyan ink present on layers of the yellow ink and the magenta ink.

As described above, in the inkjet printer shown in FIG. 4A, when discharging inks of a plurality of colors with the plurality of inkjet heads among the inkjet heads 912 to 914 to the same position in the recording medium during one relative movement of the carriage 911 with respect to the recording medium in the main scanning direction, a problem arises in that slur occurs in the color reproduced by the inks of the plurality of colors in the recording medium depending on which direction in the main scanning direction the carriage 911 is relatively moved with respect to the recording medium even if the conditions of color type and usage amount of the ink to be used are the same.

In the inkjet printer shown in FIG. 4A, when discharging the inks of the plurality of colors with the plurality of inkjet heads among the inkjet heads 912 to 914 to the same position in the recording medium, a method of causing the inkjet heads 912 to 914 to discharge ink only when the direction of the relative movement of the carriage 911 with respect to the recording medium is either the direction indicated with the arrow 901a or the direction indicated with the arrow 901b can be adopted to eliminate the slur in the color reproduced by the inks of the plurality of colors in the recording medium. However, when such method is adopted, the inkjet printer shown in FIG. 4A has a problem in that the printing speed lowers to substantially half, compared to when a method is adopted which causes the inkjet heads 912 to 914 to discharge ink regardless of whether the direction of the relative movement of the carriage 911 with respect to the recording medium is the direction indicated with the arrow 901a or the direction indicated with the arrow 901b.

Thus, an inkjet printer in which the inkjet heads 912 to 915 are arranged as shown in FIG. 4B or FIG. 4C is conventionally known for the inkjet printer that can execute printing at high speed while eliminating the slur in the reproduced color in the recording medium by the inks of the plurality of colors through the four color plate method.

The inkjet printer shown in FIG. 4B includes a carriage 921 relatively moved in the main scanning direction indicated with the arrow 901 and the sub-scanning direction indicated with the arrow 902 with respect to the recording medium (not shown). The inkjet printer 1 shown in FIG. 4B includes one yellow inkjet head 912, two magenta inkjet heads 913, two cyan inkjet heads 914, and one black inkjet head 915 on the carriage 921. The inkjet heads 914, 913, 912, 913, 914 are lined in this order in the direction indicated with the arrow 9016a. Furthermore, the inkjet head 915 is arranged such that an ink discharging range does not overlap ink discharging ranges of the inkjet heads 912 to 914 in the main scanning direction.

The inkjet printer shown in FIG. 4B discharges ink with the inkjet heads 912 to 914 to the same position in the recording medium during one relative movement of the carriage 921 with respect to the recording medium in the direction indicated with the arrow 901a when discharging ink with the inkjet heads 912 to 914 to the same position in the recording medium. The inkjet printer shown in FIG. 4B discharges ink with the inkjet heads 912 to 914 to the same position in the recording medium during one relative movement of the carriage 921 with respect to the recording medium in the direction indicated with the arrow 901b when discharging ink with the inkjet heads 912 to 914 to the same position in the recording medium.

When discharging the ink with the inkjet heads 912 to 914 to the same position in the recording medium during one relative movement of the carriage 921 with respect to the recording medium in the direction indicated with the arrow 901a,the inkjet printer shown in FIG. 4B, for example, attaches the cyan ink onto the recording medium with the inkjet head 914, attaches the magenta ink onto the cyan ink with the inkjet head 913, and attaches the yellow ink onto the magenta ink with the inkjet head 912 when discharging the ink with the inkjet head 912 and the inkjet heads 913, 914 located on the direction indicated with the arrow 901a with respect to the inkjet head 912 to the same position in the recording medium during one relative movement of the carriage 921 with respect to the recording medium in the direction indicated with the arrow 901a. When discharging the ink with the inkjet head 912 and the inkjet heads 913, 914 located on the direction indicated with the arrow 901b with respect to the inkjet head 912 to the same position in the recording medium during one relative movement of the carriage 921 with respect to the recording medium in the direction indicated with the arrow 901a, for example, the inkjet printer shown in FIG. 4B attaches the yellow ink onto the recording medium with the inkjet head 912, attaches the magenta ink onto the yellow ink with the inkjet head 913, and attaches the cyan ink onto the magenta ink with the inkjet head 914.

When discharging the ink with the inkjet heads 912 to 914 to the same position in the recording medium during one relative movement of the carriage 921 with respect to the recording medium in the direction indicated with the arrow 901b, the inkjet printer shown in FIG. 4B, for example, attaches the cyan ink onto the recording medium with the inkjet head 914, attaches the magenta ink onto the cyan ink with the inkjet head 913, and attaches the yellow ink onto the magenta ink with the inkjet head 912 when discharging the ink with the inkjet head 912 and the inkjet heads 913, 914 located on the direction indicated with the arrow 901b with respect to the inkjet head 912 to the same position in the recording medium during one relative movement of the carriage 921 with respect to the recording medium in the direction indicated with the arrow 901b. When discharging the ink with the inkjet head 912 and the inkjet heads 913, 914 located on the direction indicated with the arrow 901a with respect to the inkjet head 912 to the same position in the recording medium during one relative movement of the carriage 921 with respect to the recording medium in the direction indicated with the arrow 901b, the inkjet printer shown in FIG. 4B, for example, attaches the yellow ink onto the recording medium with the inkjet head 912, attaches the magenta ink onto the yellow ink with the inkjet head 913, and attaches the cyan ink onto the magenta ink with the inkjet head 914.

Therefore, when discharging inks of a plurality of colors with the plurality of inkjet heads among the inkjet head 912 and the inkjet heads 913, 914 located on the direction indicated with the arrow 901a with respect to the inkjet head 912 to the same position in the recording medium during one relative movement of the carriage 921 with respect to the recording medium in the direction indicated with the arrow 901a, and discharging the inks of the plurality of colors with the plurality of inkjet heads among the inkjet head 912 and the inkjet heads 913, 914 located on the direction indicated with the arrow 901b with respect to the inkjet head 912 to the same position in the recording medium during one relative movement of the carriage 921 with respect to the recording medium in the direction indicated with the arrow 901b, the inkjet printer shown in FIG. 4B can eliminate the slur in the color reproduced by the inks of the plurality of colors in the recording medium regardless of the direction in the main scanning direction the carriage 921 is relatively moved with respect to the recording medium. Similarly, when discharging the inks of the plurality of colors with the plurality of inkjet heads among the inkjet head 912 and the inkjet heads 913, 914 located on the direction indicated with the arrow 901b with respect to the inkjet head 912 to the same position in the recording medium during one relative movement of the carriage 921 with respect to the recording medium in the direction indicated with the arrow 901a, and discharging the inks of the plurality of colors with the plurality of inkjet heads among the inkjet head 912 and the inkjet heads 913, 914 located on the direction indicated with the arrow 901a with respect to the inkjet head 912 to the same position in the recording medium during one relative movement of the carriage 921 with respect to the recording medium in the direction indicated with the arrow 901b, the inkjet printer shown in FIG. 4B can eliminate the slur in the color reproduced by the inks of the plurality of colors in the recording medium regardless of the direction in the main scanning direction the carriage 921 is relatively moved with respect to the recording medium.

The inkjet printer shown in FIG. 4C includes a carriage 931 relatively moved in a main scanning direction indicated with the arrow 901 and a sub-scanning direction indicated with the arrow 902 with respect to the recording medium (not shown). Furthermore, the inkjet printer shown in FIG. 4C includes two yellow inkjet heads 912, two magenta inkjet heads 913, two cyan inkjet heads 914, and one black inkjet heads 915 on the carriage 931. The inkjet heads 914, 913, 912, 915, 912, 913, 914 are lined in this order in the direction indicated with the arrow 901a.

Similar to the inkjet printer shown in FIG. 4B, the slur in the color reproduced by the inks of the plurality of colors in the recording medium can be eliminated regardless of the direction in the main scanning direction the carriage 921 is relatively moved with respect to the recording medium in the inkjet printer shown in FIG. 4C as well. In other words, when discharging the inks of the plurality of colors with the plurality of inkjet heads among the inkjet heads 912 to 914 located on the direction indicated with the arrow 901a with respect to the inkjet head 915 to the same position in the recording medium during one relative movement of the carriage 931 with respect to the recording medium in the direction indicated with the arrow 901a, and discharging the inks of the plurality of colors with the plurality of inkjet heads among the inkjet heads 912 to 914 located on the direction indicated with the arrow 901b with respect to the inkjet head 915 to the same position in the recording medium during one relative movement of the carriage 931 with respect to the recording medium in the direction indicated with the arrow 901b, the inkjet printer shown in FIG. 4C can eliminate the slur in the color reproduced by the inks of the plurality of colors in the recording medium regardless of the direction in the main scanning direction the carriage 931 is relatively moved with respect to the recording medium. Similarly, when discharging the inks of the plurality of colors with the plurality of inkjet heads among the inkjet heads 912 to 914 located on the direction indicated with the arrow 901b with respect to the inkjet head 915 to the same position in the recording medium during one relative movement of the carriage 931 with respect to the recording medium in the direction indicated with the arrow 901a, and discharging the inks of the plurality of colors with the plurality of inkjet heads among the inkjet heads 912 to 914 located on the direction indicated with the arrow 901a with respect to the inkjet head 915 to the same position in the recording medium during one relative movement of the carriage 931 with respect to the recording medium in the direction indicated with the arrow 901b, the inkjet printer shown in FIG. 4C can eliminate the slur in the color reproduced by the inks of the plurality of colors in the recording medium regardless of the direction in the main scanning direction the carriage 931 is relatively moved with respect to the recording medium.

However, in the inkjet printer shown in FIG. 4B, one of the two inkjet heads 913 and one of the two inkjet heads 914 are not used during one relative movement of the carriage 921 with respect to the recording medium in the main scanning direction. Similarly, in the inkjet printer shown in FIG. 4C, one of the two inkjet heads 912, one of the two inkjet heads 913, and one of the two inkjet heads 914 are not used during one relative movement of the carriage 931 with respect to the recording medium in the main scanning direction. In other words, the inkjet printer shown in FIG. 4B or FIG. 4C has a problem in that the number of necessary inkjet heads is large compared to the inkjet printer shown in FIG. 4A.

An inkjet printer adopting a seven color plate method that executes printing with seven colors, yellow, magenta, cyan, black, red, green, and blue is conventionally known (see, e.g., Japanese Unexamined Patent Publication No. 10-044473).

The seven color plate method can reduce the usage amount of ink compared to the four color plate method, and hence smearing of ink is unlikely to occur in the recording medium. For example, as shown in FIG. 5A, the color reproduced when the usage amount of each of the yellow, magenta, and cyan inks is 100% in the four color plate method is equivalent to the color reproduced when the usage amount of the black ink is 100% in the seven color plate method. However, the usage amount of ink is, in total, 300% in the four color plate method and 100% in the seven color plate method. Furthermore, as shown in FIG. 5B, the color reproduced when the usage amount of each of the yellow, magenta, and cyan inks is 100%, 60%, and 40%, respectively, in the four color plate method is equivalent to the color reproduced when the usage amount of each of the yellow, red, and black inks is 40%, 20%, and 40%, respectively, in the seven color plate method. However, the usage amount of ink is, in total, 200% in the four color plate method and 100% in the seven color plate method. Moreover, as shown in FIG. 5C, the color reproduced when the usage amount of each of the yellow, magenta, and cyan inks is 40%, 20%, and 100%, respectively, in the four color plate method is equivalent to the color reproduced when the usage amount of each of the cyan, green, and black inks is 60%, 20%, and 20%, respectively in the seven color plate method. However, the usage amount of ink is, in total, 160% in the four color plate method and 100% in the seven color plate method. In addition, as shown in FIG. 5D, the color reproduced when the usage amount of each of the yellow, magenta, and cyan inks is 40%, 80%, and 60%, respectively, in the four color plate method is equivalent to the color reproduced when the usage amount of each of the magenta, blue, and black inks is 20%, 20%, and 40%, respectively in the seven color plate method. However, the usage amount of ink is, in total, 180% in the four color plate method and 80% in the seven color plate method. As shown in FIGS. 5A to 5D, the total usage amount of the inks in the seven color plate method becomes the same value as the maximum of the usage amount of each ink in the four color plate method, and thus is 100% at a maximum.

As shown in FIG. 6A, the inkjet printer described in Japanese Unexamined Patent Publication No. 10-044473 includes a carriage 941 relatively moved in the main scanning direction, indicated with the arrow 901, and the sub-scanning direction, indicated with the arrow 902, with respect to a recording medium (not shown).

Furthermore, the inkjet printer described in Japanese Unexamined Patent Publication No. 10-044473 includes the yellow inkjet head 912, the magenta inkjet head 913, the cyan inkjet head 914, the black inkjet head 915, a red inkjet head 946 with a nozzle row 946a arrayed in the sub-scanning direction, a green inkjet head 947 with a nozzle row 947a arrayed in the sub-scanning direction, and a blue inkjet head 948 with a nozzle row 948a arrayed in the sub-scanning direction on the carriage 941. The inkjet heads 912, 913, 914, 915, 946, 947, and 948 are lined in this order in the direction indicated with the arrow 901a.

### SUMMARY

However, when discharging inks of the plurality of colors with the plurality of inkjet heads among the inkjet heads 912 to 915 and 946 to 948 to the same position in the recording medium during one relative movement of the carriage 941 with respect to the recording medium in the main scanning direction, the inkjet printer shown in FIG. 6A has a problem in that slur occurs in the color reproduced by the inks of the plurality of colors in the recording medium, depending on which direction in the main scanning direction the carriage 941 is relatively moved with respect to the recording medium, even if the conditions of color type and usage amount of the ink to be used are the same, similarly to the inkjet printer shown in FIG. 4A.

An inkjet printer in which the inkjet heads 912 to 915 and 946 to 948 are arranged on the carriage 951 as shown in FIG. 6B is considered, similarly to the inkjet printer shown in FIG. 4C, for the inkjet printer that employs the seven color plate method and can execute high-speed printing while eliminating the slur in the color reproduced in the recording medium by the inks of the plurality of colors. However, the inkjet printer shown in FIG. 6B has a problem similar to that of the inkjet printer shown in FIG. 4C. In other words, the inkjet printer shown in FIG. 6B has a problem in that the number of necessary inkjet heads is large compared to the inkjet printer shown in FIG. 6A.

The present disclosure provides an inkjet printer that can suppress slur a color reproduced by inks of a plurality of colors when printed bi-directionally in the main scanning direction, smearing of ink in a recording medium, and number of necessary inkjet heads.

An inkjet printer of the present disclosure includes a plurality of inkjet heads that discharge ink toward a recording medium; a main scanning direction moving unit that causes the plurality of inkjet heads to relatively move in a main scanning direction with respect to the recording medium; a sub-scanning direction moving unit that causes the recording medium to relatively move in a sub-scanning direction intersecting the main scanning direction with respect to the plurality of inkjet heads; and an ink discharging unit that causes the inkjet heads to discharge ink regardless of whether a direction of relative movement of the plurality of inkjet heads with respect to the recording medium is either direction in the main scanning direction. In this inkjet printer, the plurality of inkjet heads include a plurality of primary color inkjet heads that discharge inks of primary colors different from each other, and a plurality of secondary color inkjet heads that discharge inks of secondary colors different from each other; ink discharging ranges by the primary color inkjet heads and ink discharging ranges by the secondary color inkjet heads are arranged so as not to overlap in the main scanning direction; and the ink discharging unit allows only one of the plurality of primary color inkjet heads to discharge ink and allows only one of the plurality of secondary color inkjet heads to discharge ink with respect to a same position in the recording medium.

According to such configuration, in the inkjet printer, the ink discharging ranges by the primary color inkjet heads and the ink discharging ranges by the secondary color inkjet heads are arranged so as not to overlap in the main scanning direction, and hence the direction of relative movement of the plurality of inkjet heads with respect to the recording medium in the main scanning direction does not influence the order of attachment of an ink of a primary color and an ink of a secondary color with respect to the same position in the recording medium when attaching the ink of the primary color discharged by the primary color inkjet heads and the ink of the secondary color discharged by the secondary color inkjet heads with respect to the same position in the recording medium. Furthermore, the inkjet printer allows only one of the plurality of primary color inkjet heads to discharge ink and allows only one of the plurality of secondary color inkjet heads to discharge ink with respect to the same position in the recording medium, and hence inks of a plurality of primary colors will not attach in different order to the same position in the recording medium according to the direction of the relative movement of the plurality of inkjet heads with respect to the recording medium in the main scanning direction and inks of a plurality of secondary colors will not attach in different order to the same position in the recording medium according to the direction of the relative movement of the plurality of inkjet heads with respect to the recording medium in the main scanning direction. Therefore, the inkjet printer of the present disclosure can suppress the slur in the color reproduced by the inks of a plurality of colors when printed bi-directionally in the main scanning direction.

Furthermore, the inkjet printer of the present disclosure includes the secondary color inkjet heads that discharge the inks of the secondary color, so that the secondary color does not need to be reproduced by the inks of the plurality of primary colors, and the usage amount of ink for reproducing the secondary color in the recording medium can be reduced. Therefore, the inkjet printer of the present disclosure can suppress the smearing of ink in the recording medium.

Moreover, the inkjet printer of the present disclosure has ink discharging ranges by the primary color inkjet heads and the ink discharging ranges by the secondary color inkjet heads arranged so as not to overlap in the main scanning direction, and allows only one of the plurality of primary color inkjet heads to discharge ink and allows only one of the plurality of secondary color inkjet heads to discharge ink, and thus merely needs to include one inkjet head for each type of color with regards to the ink of the primary color and the ink of the secondary color. Therefore, the inkjet printer of the present disclosure can suppress the number of necessary inkjet heads.

In the inkjet printer of the present disclosure, the plurality of inkjet heads may include a tertiary color inkjet head that discharges an ink of a tertiary color.

According to such configuration, the inkjet printer of the present disclosure includes the tertiary color inkjet head that discharges the ink of the tertiary color, and hence the tertiary color does not need to be reproduced by the inks of the plurality of primary colors or the tertiary color does not need to be reproduced by the ink of the primary color and the ink of the secondary color, and the usage amount of ink for reproducing the tertiary color in the recording medium can be reduced. Therefore, the inkjet printer of the present disclosure can suppress the smearing of ink in the recording medium.

In the inkjet printer of the present disclosure, an ink discharging range of the tertiary color inkjet head, the ink discharging ranges by the primary color inkjet heads, and the ink discharging ranges by the secondary color inkjet heads may be arranged so as not to overlap in the main scanning direction.

According to such configuration, in the inkjet printer of the present disclosure, the ink discharging ranges by the primary color inkjet heads, the ink discharging ranges by the secondary color ink the heads, and the ink discharging range by the tertiary color inkjet head are arranged so as not to overlap in the main scanning direction, and hence the direction of relative movement of the plurality of inkjet heads with respect to the recording medium in the main scanning direction does not influence the order of attachment of at least either one of the ink of the primary color and the ink of the secondary color, and the ink of the tertiary color with respect to the same position in the recording medium when attaching at least either one of the ink of the primary color discharged by the primary color inkjet heads and the ink of the secondary color discharged by the secondary color inkjet heads, and the ink of the tertiary color discharged by the tertiary color inkjet head with respect to the same position in the recording medium. Therefore, the inkjet printer of the present disclosure can suppress the slur in the color reproduced by the inks of the plurality of colors.

The inkjet printer of the present disclosure can suppress slur in a color reproduced by inks of a plurality of colors when printed bi-directionally in a main scanning direction, smearing of ink in the recording medium, and number of necessary inkjet heads.

### BRIEF DESCRIPTION OF THE DRAWINGS

FIG. 1 is a bottom view of a carriage of an inkjet printer according to one embodiment of the present disclosure;

FIG. 2 is a block diagram of the inkjet printer shown in FIG. 1;

FIG. 3A is a bottom view of the carriage shown in FIG. 1 with one inkjet head for a specific color added, and FIG. 3B is a bottom view of the carriage shown in FIG. 1 with three inkjet heads for a specific color added;

FIG. 4A is a bottom view of one example of a carriage of an inkjet printer of a four color plate method of a conventional art, FIG. 4B is a bottom view of an example of the carriage of the inkjet printer of the four color plate method of the conventional art, the example being different from the example shown in FIG. 4A, and FIG. 4C is a bottom view of an example of the carriage of the inkjet printer of the four color plate method of the conventional art, the example being different from the examples shown in FIGS. 4A and 4B;

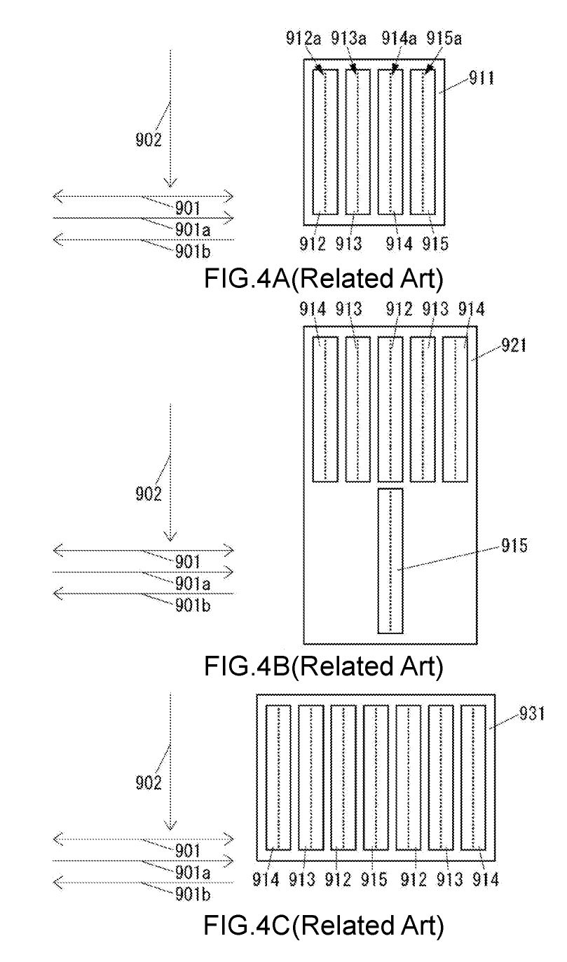

FIG. 5A is a view showing a difference of the four color plate method and a seven color plate method with respect to a specific reproduced color, FIG. 5B is a view showing a difference of the four color plate method and the seven color plate method with respect to a specific reproduced color other than the example shown in FIG. 5A, FIG. 5C is a view showing a difference of the four color plate method and the seven color plate method with respect to a specific reproduced color other than the examples shown in FIGS. 5A and 5B, and FIG. 5D is a view showing a difference of the four color plate method and the seven color plate method with respect to a specific reproduced color other than the examples shown in FIGS. 5A to 5C; and

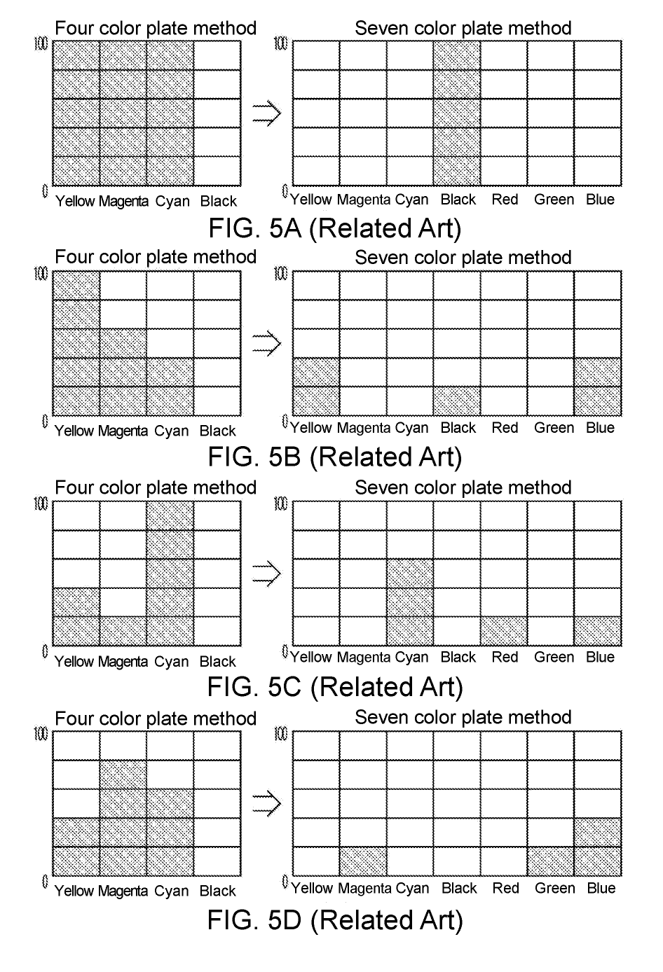

FIG. 6A is a bottom view of an example of a carriage of an inkjet printer of a seven color plate method of the conventional art, and FIG. 6B is a bottom view of an example of the carriage of the inkjet printer of the seven color plate method, the example being different from the example shown in FIG. 6A.

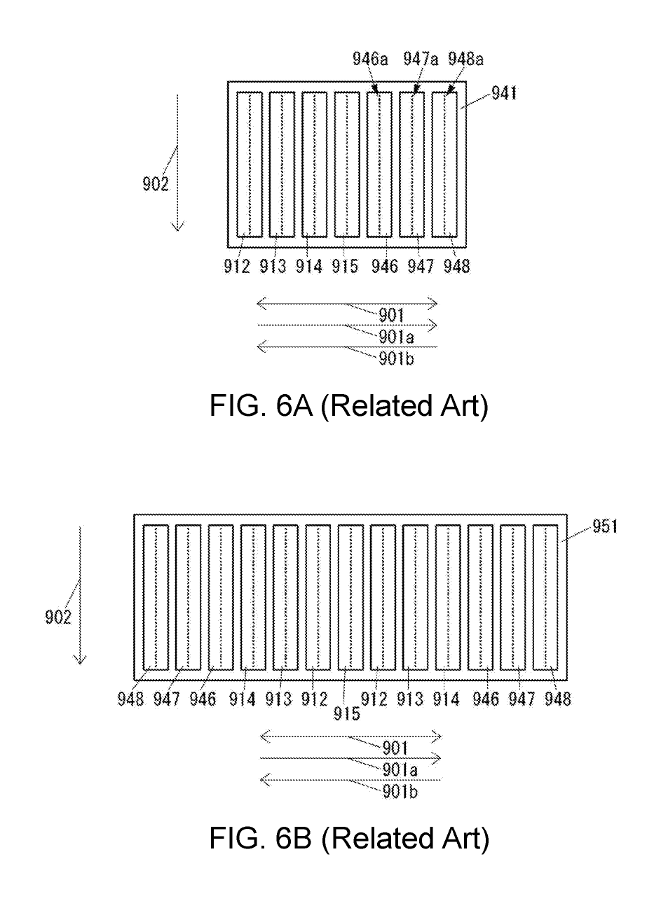

### DETAILED DESCRIPTION OF EMBODIMENTS

Hereinafter, one embodiment of the present disclosure will be described with reference to the drawings.

First, a configuration of an inkjet printer according to the present embodiment will be described.

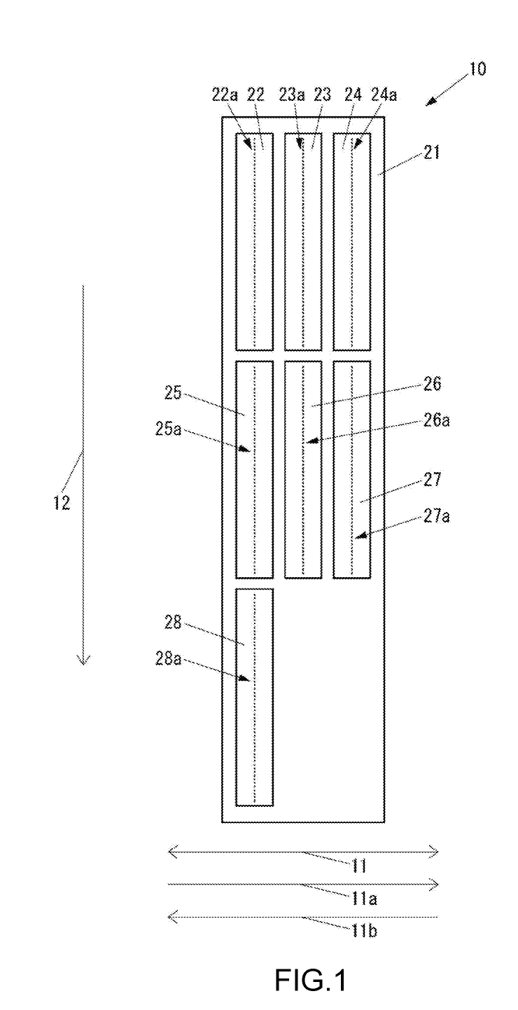

FIG. 1 is a bottom view of a carriage 21 of an inkjet printer 10 according to the present embodiment.

As shown in FIG. 1, the inkjet printer 10 includes a carriage 21 relatively moved in a main scanning direction, indicated with an arrow 11, and a sub-scanning direction, indicated with an arrow 12, orthogonal to the main scanning direction with respect to a recording medium (not shown).

The inkjet printer 10 includes, on the carriage 21, an inkjet head 22 serving as a primary color inkjet head that includes a nozzle row 22a arrayed in the sub-scanning direction and that discharges a yellow ink toward the recording medium, an inkjet head 23 serving as a primary color inkjet head that includes a nozzle row 23a arrayed in the sub-scanning direction and that discharges a magenta ink toward the recording medium, an inkjet head 24 serving as a primary color inkjet head that includes a nozzle row 24a arrayed in the sub-scanning direction and that discharges a cyan ink toward the recording medium, an inkjet head 25 serving as a secondary color inkjet head that includes a nozzle row 25a arrayed in the sub-scanning direction and that discharges a red ink toward the recording medium, an inkjet head 26 serving as a secondary color inkjet head that includes a nozzle row 26a arrayed in the sub-scanning direction and that discharges a green ink toward the recording medium, an inkjet head 27 serving as a secondary color inkjet head that includes a nozzle row 27a arrayed in the sub-scanning direction and that discharges a blue ink toward the recording medium, and an inkjet head 28 serving as a tertiary color inkjet head that includes a nozzle row 28a arrayed in the sub-scanning direction and that discharges a black ink toward the recording medium. In other words, the inkjet printer 10 is an inkjet printer adopting a seven color plate method.

The inkjet heads 22 to 24 have ink discharging ranges arranged in line in the main scanning direction. The inkjet heads 22, 23, 24 are lined in this order in a direction indicated with an arrow 11a in the main scanning direction. The inkjet heads 22 to 24 are arranged such that their ink discharging ranges do not overlap ink discharging ranges of the inkjet heads 25 to 28 in the main scanning direction.

The inkjet heads 25 to 27 have ink discharging ranges arranged in line in the main scanning direction. The inkjet heads 25, 26, 27 are lined in this order in the direction indicated with the arrow 11a. The inkjet heads 25 to 27 are arranged such that their ink discharging ranges do not overlap an ink discharging range of the inkjet head 28 in the main scanning direction.

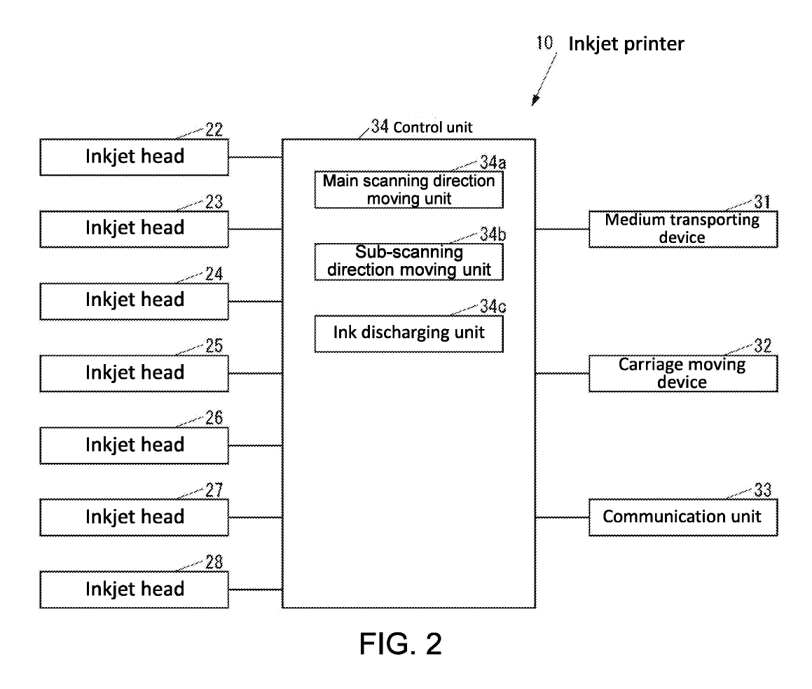

FIG. 2 is a block diagram of the inkjet printer 10.

As shown in FIG. 2, the inkjet printer 10 includes a medium transporting device 31 that transports the recording medium in the sub-scanning direction with respect to the carriage 21 (see FIG. 1), a carriage moving device 32 that moves the carriage 21 in the main scanning direction with respect to the recording medium, a communication unit 33, namely, a communication device that carries out communication with an external device directly in a wired or wireless manner without through a network such as LAN (Local Area Network) and the like, or through the network, and a control unit 34 that controls the entire inkjet printer 10.

The control unit 34 includes, for example, a CPU (Central Processing Unit), a ROM (Read Only Memory) storing programs and various types of data in advance, and a RAM (Random Access Memory) used as a work region of the CPU. The CPU executes the program stored in the ROM.

The control unit 34 executes the program stored in the ROM and thereby functions as a main scanning direction moving unit 34a that relatively moves the carriage 21 in the main scanning direction with respect to the recording medium by means of the carriage moving device 32, as a sub-scanning direction moving unit 34b that relatively moves the recording medium in the sub-scanning direction with respect to the carriage 21 by means of the medium transporting device 31, and as an ink discharging unit 34c that causes the inkjet heads 22 to 28 to discharge ink, no matter in which direction in the main scanning direction the carriage 21 is relatively moved with respect to the recording medium.

Next, an operation of the inkjet printer 10 will be described.

The control unit 34 drives the inkjet heads 22 to 28, the medium transporting device 31, and the carriage moving device 32 based on print data input through the communication unit 33. Specifically, the ink discharging unit 34c discharges ink 11a toward the recording medium with the inkjet heads 22 to 28 while moving the inkjet heads 22 to 28 in the main scanning direction by means of the main scanning direction moving unit 34a every time the position of the recording medium in the sub-scanning direction with respect to the carriage 21 is changed by the sub-scanning direction moving unit 34b to form an image based on the print data with respect to the recording medium with ink. The ink discharging unit 34c allows only one of the inkjet heads 22 to 24 to discharge ink and allows only one of the inkjet heads 25 to 27 to discharge ink with respect to the same position in the recording medium. In other words, the inkjet heads 22 to 24 do not discharge ink to the same position in the recording medium. Similarly, the inkjet heads 25 to 27 do not discharge ink to the same position in the recording medium. In the seven color plate method, when an arbitrary color is reproduced by a plurality of colors, the primary color is not used in plurals and the secondary color is also not used in plurals.

As described above, in the inkjet printer 10, the ink discharging ranges by the inkjet heads 22 to 24, the ink discharging ranges by the ink the heads 25 to 27, and the ink discharging range by the inkjet head 28 are arranged so as not to overlap in the main scanning direction, and hence the direction of relative movement of the carriage 21 with respect to the recording medium in the main scanning direction does not influence the order of attachment of an ink of a primary color, an ink of a secondary color, and an ink of a tertiary color with respect to the same position in the recording medium when attaching the ink of the primary color discharged by the inkjet heads 22 to 24, the ink of the secondary color discharged by the inkjet heads 25 to 27, and the ink of the tertiary color discharged by the inkjet head 28 with respect to the same position in the recording medium. In other words, when attaching the ink of the primary color, the ink of the secondary color, and the ink of the tertiary color to the same position in the recording medium, the inkjet printer 10 attaches the ink of the tertiary color on the recording medium with the inkjet head 28, attaches the ink of the secondary color on the recording medium with one of the inkjet heads 25 to 27, and then attaches the ink of the primary color on the recording medium with one of the inkjet heads 22 to 24. Therefore, the inkjet printer 10 can suppress the slur in the color reproduced by the inks of a plurality of colors.

Furthermore, the inkjet printer 10 allows only one of the inkjet heads 22 to 24 to discharge ink and allows only one of the inkjet heads 25 to 27 to discharge ink with respect to the same position in the recording medium, and hence inks of a plurality of primary colors will not attach in different order to the same position in the recording medium according to the direction of the relative movement of the carriage 21 with respect to the recording medium in the main scanning direction and inks of a plurality of secondary colors will not attach in different order to the same position in the recording medium according to the direction of the relative movement of the carriage 21 with respect to the recording medium in the main scanning direction. Therefore, the inkjet printer 10 can suppress the slur in the color reproduced by the inks of a plurality of colors when printed bi-directionally in the main scanning direction.

Furthermore, since the inkjet printer 10 includes the inkjet heads 25 to 27 that discharge the inks of the secondary color, the secondary color does not need to be reproduced with the inks of the plurality of primary colors, and the usage amount of ink necessary for reproducing the secondary color in the recording medium can be reduced. Therefore, the inkjet printer 10 can suppress the smearing of ink in the recording medium. Similarly, since the inkjet printer 10 includes the inkjet head 28 that discharges the ink of the tertiary color, the tertiary color does not need to be reproduced by the inks of the plurality of primary colors or the tertiary color does not need to be reproduced by the ink of the primary color and the ink of the secondary color, and the usage amount of ink necessary for reproducing the tertiary color in the recording medium can be reduced. Therefore, the inkjet printer 10 can suppress the smearing of ink in the recording medium. The inkjet printer 10 does not attach the inks of the plurality of colors in an overlapping manner to the same position in the recording medium during one relative movement of the carriage 21 with respect to the recording medium in either direction of the main scanning direction, that is, during the same path, and thus can suppress the smearing of ink in the recording medium.

In the actual ink, an ideal red cannot actually be obtained even if yellow and magenta are mixed. Similarly, in the actual ink, an ideal green cannot actually be obtained even if yellow and cyan are mixed, and an ideal blue cannot actually be obtained even if magenta and cyan are mixed. Therefore, the seven color plate method using the inks of secondary colors can clearly print the secondary color without turbidity compared to the four color plate method of generating the secondary color by combining the primary colors.

Furthermore, the inkjet printer 10 has the ink discharging ranges by the inkjet heads 22 to 24 and the ink discharging ranges by the inkjet heads 25 to 27 arranged so as not to overlap in the main scanning direction, and allows only one of the inkjet heads 22 to 24 to discharge ink and allows only one of the inkjet heads 25 to 27 to discharge ink, and thus merely needs to include one inkjet head for each type of color with regards to the ink of the primary color and the ink of the secondary color. Therefore, the inkjet printer 10 can suppress the number of necessary inkjet heads.

As the inkjet printer 10 can suppress the number of necessary inkjet heads, the carriage 21 on which the inkjet heads are mounted can be miniaturized. Furthermore, as the inkjet printer 10 can suppress the number of necessary inkjet heads, the manufacturing cost can be reduced.

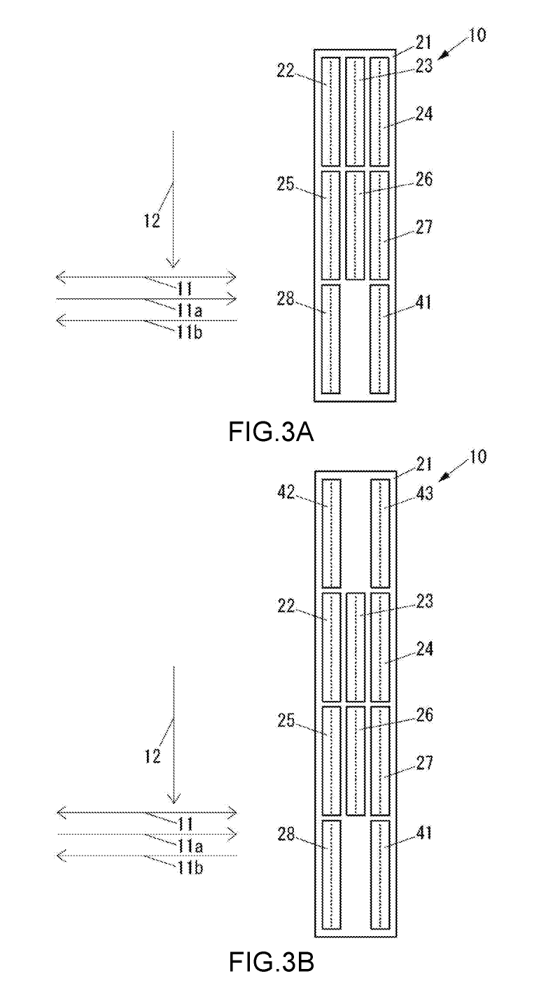

The inkjet printer 10 may include one inkjet head 41 for discharging an ink of a specific color other than yellow, magenta, cyan, red, green, blue, and black as shown in FIG. 3A, or may include inkjet heads 41 to 43 for discharging inks of a specific color as shown in FIG. 3B. The inkjet printer 10 can include an arbitrary number of inkjet heads for discharging the ink of a specific color. An arbitrary specified color, such as white, metallic, pearl, fluorescent, clear, gray, orange, yellowish green, color of company logo mark (corporate color), and the like, can be adopted for the specific color. The inkjet head for discharging the ink of a specific color may have an ink discharging range arranged in line in the main scanning direction with the ink discharging range by one of the inkjet heads 22 to 28, or may have the ink discharging range arranged so as not to overlap with any ink discharging ranges of the inkjet heads 22 to 28 in the main scanning direction.

The inkjet printer 10 moves the carriage 21 in the main scanning direction with respect to the recording medium in the present embodiment, but does not need to move the carriage 21 in the main scanning direction with respect to the recording medium as long as the carriage 21 is relatively moved in the main scanning direction with respect to the recording medium. For example, the inkjet printer 10 may move the recording medium in the main scanning direction with respect to the carriage 21.

The inkjet printer 10 moves the recording medium in the sub-scanning direction with respect to the carriage 21 in the present embodiment, but does not need to move the recording medium in the sub-scanning direction with respect to the carriage 21 as long as the recording medium is relatively moved in the sub-scanning direction with respect to the carriage 21. For example, the inkjet printer 10 may move the carriage 21 in the sub-scanning direction with respect to the recording medium.

The inkjet printer 10 has the primary color inkjet head, the secondary color inkjet head, and the tertiary color inkjet head in this order from upstream to downstream in the sub-scanning direction. However, the inkjet printer 10 may have the inkjet heads arranged in other orders.

The inkjet heads 22 to 24 have ink discharging ranges arranged in line in the main scanning direction in the present embodiment. However, the inkjet heads 22 to 24 may not have the ink discharging ranges arranged in line in the main scanning direction with respect to each other as long as the ink discharging ranges are arranged so as not to overlap with any of the ink discharging ranges by the inkjet heads 25 to 27 in the main scanning direction. For example, the ink discharging ranges by some of the inkjet heads 22 to 24 and the ink discharging ranges by the rest of the inkjet heads 22 to 24 may be arranged so as not to overlap in the main scanning direction.

Similarly, the inkjet heads 25 to 27 may not have the ink discharging ranges arranged in line in the main scanning direction with respect to each other as long as the ink discharging ranges are arranged so as not to overlap with any of the ink discharging ranges by the inkjet heads 22 to 24 in the main scanning direction. For example, the ink discharging ranges by some of the inkjet heads 25 to 27 and the ink discharging ranges by the rest of the inkjet heads 25 to 27 may be arranged so as not to overlap in the main scanning direction.

The inkjet head 28 is arranged such that the ink discharging range does not overlap with any of the ink discharging ranges by the inkjet heads 22 to 27 in the main scanning direction in the present embodiment. However, the inkjet head 28 may have the ink discharging range arranged in line with one of the ink discharging ranges by the inkjet heads 22 to 27 in the main scanning direction.

The ink used in the inkjet printer 10 is not limited to the ink of a specific type. For example, various inks such as aqueous dye ink, aqueous pigment ink, latex ink, aqueous UV ink, SUV (solvent diluted UV) ink, UV ink, aqueous UV curing dye ink, and the like can be adopted for the ink used in the inkjet printer 10.

The inkjet printer 10 can be configured as an arbitrary inkjet printer. For example, the inkjet printer 10 can be configured as a textile printer, an indoor/outdoor signage printer, T-shirt printer, industrial UV printer, decorating printer, and the like.

What is claimed is:

1. An inkjet printer comprising:
a plurality of inkjet heads that discharge ink toward a recording medium;
a main scanning direction moving unit that causes the plurality of inkjet heads to relatively move in a main scanning direction with respect to the recording medium;
a sub-scanning direction moving unit that causes the recording medium to relatively move in a sub-scanning direction intersecting the main scanning direction with respect to the plurality of inkjet heads; and
an ink discharging unit that causes the plurality of inkjet heads to discharge ink regardless of whether a direction of relative movement of the plurality of inkjet heads with respect to the recording medium is either direction in the main scanning direction,
wherein
the plurality of inkjet heads include:
a plurality of primary color inkjet heads that discharge inks of primary colors different from each other; and
a plurality of secondary color inkjet heads that discharge inks of secondary colors different from each other,
ink discharging ranges by the primary color inkjet heads and ink discharging ranges by the secondary color inkjet heads are arranged so as not to overlap in the main scanning direction, and
the ink discharging unit allows only one of the plurality of primary color inkjet heads to discharge ink and allows only one of the plurality of secondary color inkjet heads to discharge ink with respect to a same position in the recording medium.

2. The inkjet printer according to claim 1, wherein the plurality of inkjet heads include a tertiary color inkjet head that discharges an ink of a tertiary color.

3. The inkjet printer according to claim 2, wherein an ink discharging range of the tertiary color inkjet head, the ink discharging ranges by the primary color inkjet heads, and the ink discharging ranges by the secondary color inkjet heads are arranged so as not to overlap in the main scanning direction.
